(19) United States
(12) Patent Application Publication
(10) Pub. No.: US 2011/0113272 A1
(43) Pub. Date: May 12, 2011

(54) PROJECTOR AND POWER CONTROL METHOD THEREOF

(75) Inventors: Ming-Lung Tsai, Hsin-Chu (TW); Wen-Chang Chien, Hsin-Chu (TW)

(73) Assignee: CORETRONIC CORPORATION, Hsin-Chu (TW)

(21) Appl. No.: 12/842,049

(22) Filed: Jul. 23, 2010

(30) Foreign Application Priority Data
Nov. 10, 2009 (CN) 200910212108.6

(51) Int. Cl. G06F 1/32; G06F 1/30

(52) U.S. Cl. 713/320; 713/340

(57) ABSTRACT

A projector and a power control method thereof are provided. The projector includes a battery supplying a battery power; an interface receiving and transmitting an external power; a selection unit receiving the battery power and the external power, and selecting and outputting one of the battery power and the external power to be served as the operation voltage of the projector; a lighting element; a driver receiving a driving signal and driving the lighting element accordingly; and a central processing unit (CPU) outputting a control signal with a first state to control the selection unit to select and output the external power when the capacity of the battery is not sufficient and the interface receives the external power, and regulating the intensity of the driving signal outputted from the CPU according to the capacity of the external power so as to make the projector continuously maintain in operation.

### CROSS-REFERENCE TO RELATED APPLICATION

This application claims the priority benefit of China application serial no. 200910212108.6, filed on Nov. 10, 2009. The entirety of the above-mentioned patent application is hereby incorporated by reference herein and made a part of specification.

### BACKGROUND OF THE INVENTION

1. Field of the Invention

The invention relates to a projector, and more particularly, to a projector and a power control method thereof.

2. Description of Related Art

In general, projectors may project images on a larger screen, so the projectors are convenient for a lot of people to watch the images shown on the screen together. Therefore, the projectors are usually applied in public areas such as company, school, and the like. Moreover, as a big-size tendency in household display device, the projection apparatus is also becoming popular in the general family. Therefore, the projector has turned into a common electronic device in modern life.

With the progress of the science and technology, every electronic product has been developed towards high speed, high efficiency, light weight and compact size. Accordingly, along with the trend, portable pico-projector (or mini-projector) has gradually become the mainstream in the future personal digital market. In general, the portable pico-projector uses the light emitting diode (LED) or other solid-state optical sources so as to increase the needed luminance and hence increase the brightness of the projected image.

After the pico-projector is fabricated into the final product, the size of the battery inside the pico-projector is similar to the size of the battery inside the ordinary cell phones in the market. Because of the light weight, compact size, and portability of the portable pico-projector, there is less limitation on the sites for operation. In addition, since the battery inside the pico-projector is generally expected to provide the power for several hours, the provided power sufficiently meets the usual requirements for the entertainment purpose such as watching a movie with about 150 minutes long. As for the business purpose, the pico-projector may project the images with the size from 2 to 100 inches according to the requirements of the conference presentation.

However, as the capacity of the battery inside the pico-projector is insufficient, a power adaptor should be connected externally by a user so as to make the pico-projector maintain in operation. Since the capacity of the battery inside the pico-projector is limited, users usually encounter/worry about the problem of insufficient battery power. On the other hand, to cope with projection for longer time, users have to carry bulky power adaptors around. Therefore, it is troublesome to the users.

To resolve the aforementioned problem, TW Patent No. 1307808 discloses a projection apparatus having a universal serial bus (USB) interface for retrieving the required power for the projection apparatus to operate by connecting to the USB interface of the desktop or the laptop device when the capacity of the battery inside the projection apparatus is insufficient. However, because of the limited power (generally 2.5 W) which the USB interface of the desktop or the laptop device may provide, the entire power consumption of the projection apparatus may not be met. Consequently, the projection apparatus may shut down and is unable to maintain in operation. Besides, patent related to provide USB power further includes TW Patent No. 1244327.

### SUMMARY OF THE INVENTION

Accordingly, the invention is directed to a projector capable of maintaining in operation by receiving the USB power.

In order to achieve one or a portion of or all of the objects or other objects, one embodiment of the invention is directed to a projector including a battery, an interface, a selection unit, a lighting element, a driver, and a central processing unit (CPU). The battery is used for providing a battery power. The interface is used for receiving and transmitting an external power. The selection unit is electrically coupled to the battery and the interface, and used for receiving the battery power and the external power, and selecting and outputting one of the battery power and the external power to be served as an operation voltage of the projector according to a control signal. The driver is electrically coupled to the lighting element, and used for receiving a driving signal and driving the lighting element accordingly. The CPU is electrically coupled to the battery, the interface, the selection unit, and the driver, and used for outputting the control signal with a first state to control the selection unit to select and output the external power when the capacity of the battery is insufficient and the interface receives the external power, and regulating an intensity of the driving signal outputted from the CPU according to the capacity of the external power so as to make the projector continuously maintain in operation.

In one embodiment of the invention, the CPU further outputs the control signal with a second state to control the selection unit to select and output the battery power when the capacity of the battery is sufficient.

In one embodiment of the invention, the CPU continuously detects the battery power to determine whether the capacity of the battery is sufficient. The CPU outputs the control signal with the second state when the CPU detects the capacity of the battery is sufficient, and the CPU outputs the control signal with the first state and detects whether the interface receives the external power when the CPU detects the capacity of the battery is insufficient.

In one embodiment of the invention, the CPU executes a normal shutdown procedure to shut down the projector when the interface without receiving the external power is detected by the CPU.

In one embodiment of the invention, the CPU outputs the control signal with the first state when the interface with receiving the external power is detected by the CPU.

In one embodiment of the invention, the CPU further regulates the intensity of the driving signal to a minimum magnitude for regulating the brightness of the lighting element to the minimum brightness, and continuously detects a voltage level of the external power received by the interface after the CPU outputs the control signal with the first state.

In one embodiment of the invention, the battery is a chargeable battery, and the selection unit further feeds back the external power to charge the chargeable battery after the CPU outputs the control signal with the first state.

In one embodiment of the invention, the CPU further increases the intensity of the driving signal gradually until the voltage level falls to a predetermined voltage level after the CPU regulates the brightness of the lighting element to the minimum brightness.

In one embodiment of the invention, the driver continuously drives the lighting element with the intensity of the driving signal corresponding to the predetermined voltage level when the voltage level is not less than the predetermined voltage level.

In one embodiment of the invention, the CPU continuously determines whether the brightness of the lighting element is the minimum brightness when the voltage level detected by the CPU is lower than the predetermined voltage level.

In one embodiment of the invention, the CPU executes the normal shutdown procedure to shut down the projector when the brightness of the lighting element determined by the CPU is the minimum brightness.

In one embodiment of the invention, the CPU decreases the intensity of the driving signal gradually until the voltage level rises back to the predetermined voltage level when the brightness of the lighting element determined by the CPU is not the minimum brightness.

In one embodiment of the invention, the predetermined voltage level is determined by the capacity of the external power, and the capacity of the external power is a number of watts capable of being supplied by the external power.

In one embodiment of the invention, the interface at least comprises a universal serial bus (USB) interface.

In one embodiment of the invention, the external power is provided by an apparatus equipped with the USB interface.

Another embodiment of the invention provides a power control method adapted to the above-mentioned projector. The power control method includes detecting whether the capacity of a battery of the projector is sufficient when the projector is in the power-on state; detecting whether an interface of the projector receives an external power when the capacity of the battery is insufficient; and regulating the intensity of a driving signal according to the capacity of the external power so as to make the projector continuously maintain in operation when the interface receives the external power.

In one embodiment of the invention, the step of regulating the intensity of the driving signal includes regulating the intensity of the driving signal to a minimum magnitude for regulating the brightness of the lighting element to the minimum brightness and continuously detecting a voltage level of the external power; increasing the intensity of the driving signal gradually until the voltage level falls to a predetermined voltage level; and driving the lighting element continuously with the intensity of the driving signal corresponding to the predetermined voltage level when the voltage level is not less than the predetermined voltage level.

In one embodiment of the invention, the step of regulating the intensity of the driving signal further includes determining whether the brightness of the lighting element is the minimum brightness when the voltage level detected is lower than the predetermined voltage level; executing a normal shutdown procedure to shut down the projector when the brightness of the lighting element is the minimum brightness; and decreasing the intensity of the driving signal gradually until the voltage level rises back to the predetermined voltage level when the brightness of the lighting element is not the minimum brightness.

In one embodiment of the invention, the battery power is provided to make the projector continuously maintain in operation when the capacity of the battery is sufficient.

In one embodiment of the invention, the normal shutdown procedure is executed to shut down the projector when the capacity of the battery is insufficient and the interface is not receiving the external power.

In summary, the embodiment or embodiments of the invention may have at least one of the following advantages.

The projector may regulate the power consumption for adapting to the number of watts supplied by a variety of external powers (e.g. USB power). Consequently, the projector is capable of long-term operation without limiting to the capacity of the battery and carrying bulky power adaptors around.

Other objectives, features and advantages of the invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram of a projection system according to an embodiment of the invention.

FIG. 2 is a flow chart of a power control method according to an embodiment of the invention.

### DESCRIPTION OF EMBODIMENTS

It is to be understood that other embodiment may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

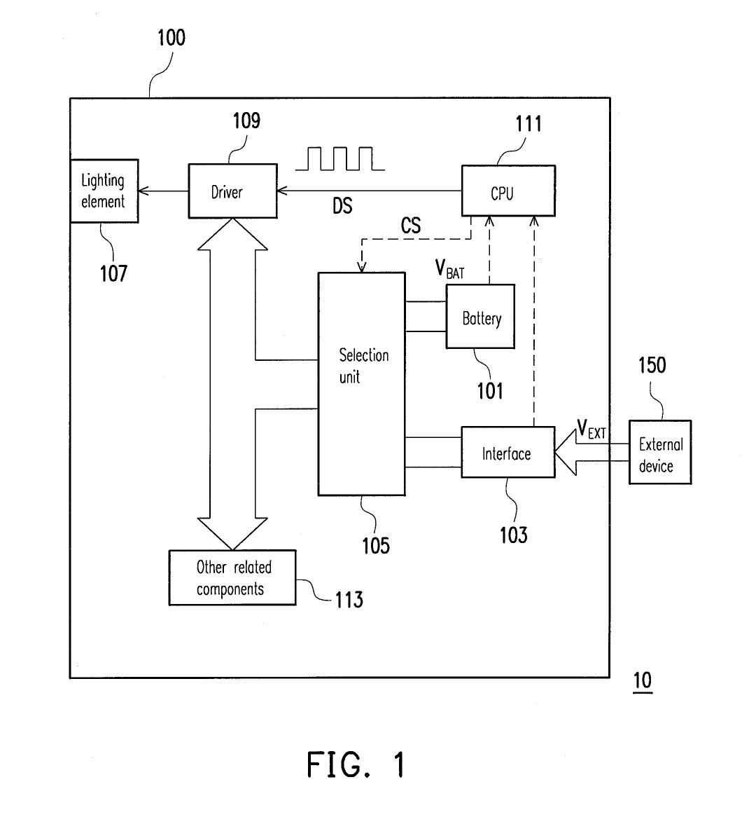

Referring to FIG. 1, the projection system 10 includes a projector 100 and an external device 150. The projector 100 may be a portable pico-projector, but not limited thereto. The projector 100 includes a battery 101, an interface 103, a selection unit 105, a lighting element 107, a driver 109, a central processing unit (CPU) 111, and other related components 113. The battery 101 is used for providing a battery power V_{BAT}. The interface 103 is used for receiving and transmitting an external power V_{EXT} provided by the external device 150.

In the embodiment, the interface 103 may be a universal serial bus (USB) interface (but not limited thereto), and therefore may electrically connect with the external device 150 having USB interfaces through a USB cable (not shown). The external device 150 may be a desktop computer device, a laptop computer device, and/or an external battery bank, but not limited to thereto.

The selection unit 105 is electrically coupled to the battery 101 and the interface 103. The selection unit 105 is used for receiving the battery power V_{BAT} provided by the battery 101 and the external power V_{EXT} provided by the external device 150, and selecting and outputting one of the battery power V_{BAT} and the external power V_{EXT} to be served as an operation voltage of the projector 100 according to a control signal CS outputted from the CPU 111. The lighting element 107 may be a light emitting diode (LED), for example, but is not limited thereto. The driver 109 is electrically coupled to the lighting element 107, and used for receiving the driving signal DS outputted from the CPU 111 and driving the lighting element 107 accordingly.

The CPU 111 is electrically coupled to the battery 101, the interface 103, the selection unit 105, and the driver 109. The CPU 111 is used for continuously detecting the battery power V_{BAT} provided by the battery 101 to determine whether the capacity of the battery 101 is sufficient, and continuously detecting whether the interface 103 receives the external power V_{EXT} provided by the external device 150. In the embodiment, the CPU 111 outputs the control signal CS with logical low, for example, to the selection unit 105 so as to make the selection unit 105 select and output the battery power V_{BAT} provided by the battery 101 when the capacity of the battery 101 detected by the CPU 111 is sufficient.

On the other hand, the CPU 111 may further detect whether the interface 103 receives the external power V_{EXT} provided by the external device 150 when the capacity of the battery 101 detected by the CPU 111 is insufficient. In the embodiment, the CPU 111 executes the normal shutdown procedure to shut down the projector 100 when the capacity of the battery 101 detected by the CPU 111 is insufficient and the interface 103 without receiving the external power V_{EXT} provided by the external device 150 (i.e., the projector 100 now is not connected with the external device 150) is detected by the CPU 111.

However, the CPU 111 outputs the control signal CS with logical high, for example, to control the selection unit 105 to select and output the external power V_{EXT} and regulates a intensity of the driving signal DS outputted from the CPU 111 according to the capacity of the external power V_{EXT} (i.e., the number of watts capable of being supplied by the external power V_{EXT}) so as to make the projector 100 continuously maintain in operation when the capacity of the battery 101 detected by the CPU 111 is insufficient and the interface 103 with receiving the external power V_{EXT} provided by the external device 150 (i.e., the projector 100 now is connected with the external device 150) is detected by the CPU 111.

In general, since the external power V_{EXT} provided by the single-port USB interface (not shown) of the external device 150 is 5V/2.5 W, the entire power consumption of the projector 100 may not be satisfied, so that the projector 100 may shut down and not maintain in operation. Accordingly, after the CPU 111 outputs the control signal CS with logical high, the CPU 111 further regulates the intensity of the driving signal DS to a minimum magnitude for regulating the brightness of the lighting element 107 to a minimum brightness and thus preventing the projector 100 to shut down, and the CPU 111 continuously detects the voltage level of the external power V_{EXT} received by the interface 103.

In the embodiment, since the lighting element 107 is the LEDs, the CPU 111 may output the driving signal DS such as the pulse width modulation (PWM) signal for the driver 109 to drive the lighting element 107. Herein, assuming the resolution of the PWM signal outputted from the CPU 111 is 10-bit (but not limited thereto), then the magnitude difference of the driving signal DS is 1024 (2¹⁰) levels and the minimum magnitude of the driving signal DS is the 200^{th} level, for example (but not limited thereto).

The CPU 111 increases the intensity of the driving signal DS gradually (such as increasing progressively/gradually starting from the 200^{th} level) until the voltage level (i.e., 5V) of the external power V_{EXT} received by the interface 103 falls to a predetermined voltage level (e.g. 4.8V, but not limited thereto, and the predetermined voltage level is determined by the capacity of the external power V_{EXT}, specifically, the capacity of the external power V_{EXT} is the number of watts capable of being supplied by the external power V_{EXT}) after the CPU 111 regulates the brightness of the lighting element 107 to the minimum brightness.

That is to say, the driver 109 drives the lighting element 107 continuously with the intensity of the driving signal DS (e.g. the 700^{th} level, but not limited thereto) corresponding to the predetermined voltage level when the voltage level of the external power V_{EXT} received by the interface 103 is not less than the predetermined voltage level. Consequently, although the brightness of the lighting element 107 is sacrificed partly, the projector 100 may continuously maintain in operation.

On the other hand, the CPU 111 may further determine whether the brightness of the lighting element 107 is the minimum brightness when the voltage level of the external power V_{EXT} received by the interface 103 and detected by the CPU 111 is lower than the predetermined voltage level detected by the CPU 111 (i.e., beyond the number of watts capable of being supplied by the external power V_{EXT}). The CPU 111 executes the normal shutdown procedure to shut down the projector 100 when the brightness of the lighting element 107 determined by the CPU 111 is the minimum brightness. However, the CPU 111 decreases the intensity of the driving signal DS gradually until the voltage level of the external power V_{EXT} received by the interface 103 rises back to the predetermined voltage level when the brightness of the lighting element 107 determined by the CPU 111 is not the minimum brightness.

In summary, the CPU 111 may make the projector 100 continuously maintain in operation as long as the external power V_{EXT} provided by the single-port USB interface of the external device 150 is capable of keeping the lighting element 107 in the minimum brightness. However, the CPU 111 may execute the normal shutdown procedure to shut down the projector 100 when the external power V_{EXT} provided by the single-port USB interface of the external device 150 is incapable of keeping the lighting element 107 in the minimum brightness.

On the other hand, although the aforementioned embodiment is illustrated with the single-port USB interface, the dual-port or above USB interface may also be used to provide the power with more watts (e.g. 5V/5 W, 5V/7.5 W, or 5V/10 W) to the projector 100 in the other embodiments of the invention. Consequently, the projector 100 may maintain in the normal operation. Besides, the logical state of the control signal CS may be modified according to requirements of actual designs. In other words, provided that the operations corresponding to the aforementioned embodiment are hold, logical high may be modified to logical low and logical low may be modified to logical high.

Furthermore, in the other embodiments of the invention, the battery 101 may be a chargeable battery, such that the selection unit 105 may further feed back the external battery V_{EXT} to charge the chargeable battery 101 besides the selection unit 105 selecting and outputting the external battery V_{EXT} received by the interface 103 after the CPU 111 outputs the control signal CS with logical high.

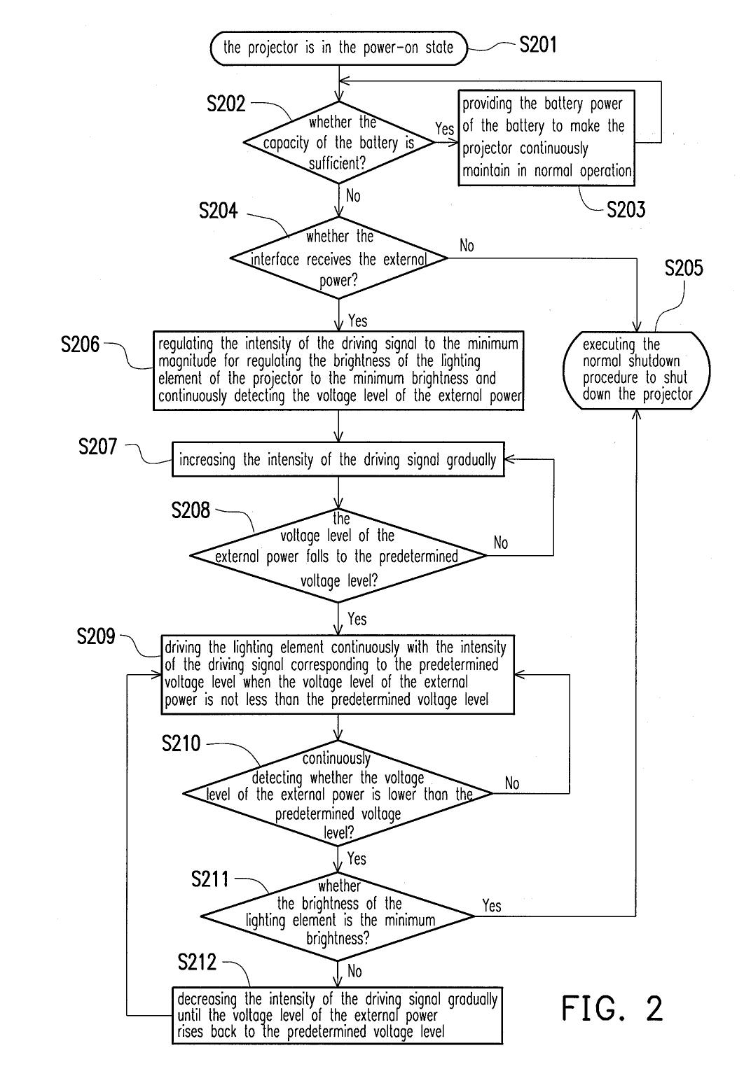

Based on the disclosure of the aforesaid embodiments, FIG. 2 is a flow chart of a power control method according to an embodiment of the invention. Referring to FIGS. 1 and 2, the power control method of the embodiment is adapted to the projector 100 of the aforementioned embodiments and includes the following steps of detecting whether the capacity of the battery 101 is sufficient (step S202) when the projector 100 is in the power-on state (step S201). In the embodiment, the battery power V_{BAT} is provided to make the projector 100 continuously maintain in normal operation (step S203) when the capacity of the battery 101 is sufficient. On the other hand, detecting whether the interface 103 receives the external battery V_{EXT} (step S204) when the capacity of the battery 101 is insufficient.

The normal shutdown procedure is executed to shut down the projector 100 (step S205) when the capacity of the battery 101 is insufficient and the interface 103 is not receiving the external power V_{EXT}. On the other hand, the intensity of the driving signal DS is regulated according to the capacity of the external power V_{EXT} so as to make the projector 100 continuously maintain in operation (steps S206˜S212) when the capacity of the battery 101 is insufficient and the interface 103 receives the external power V_{EXT}.

More specifically, the intensity of the driving signal DS is regulated to the minimum magnitude first so as to regulate the brightness of the lighting element 107 to the minimum brightness and the voltage level of the external power V_{EXT} is detected continuously (step S206) when the interface 103 with receiving the external power V_{EXT} is detected in the step S204. Then, the intensity of the driving signal DS is increased gradually (step S207) until the voltage level (i.e., 5V) of the external power V_{EXT} falls to the predetermined voltage level (e.g. 4.8V, but not limited thereto) (step S208). Afterwards, the lighting element 107 is continuously driven with the intensity of the driving signal DS corresponding to the predetermined voltage level when the voltage level of the external power V_{EXT} is not less than the predetermined voltage level (step S209).

After the step S209, detecting whether the voltage level of the external power V_{EXT} is lower than the predetermined voltage level (step S210). Determining whether the brightness of the lighting element 107 is the minimum brightness when the voltage level of the external power V_{EXT} is detected lower than the predetermined voltage level (step S211). In the embodiment, the normal shutdown procedure is executed to shut down the projector 100 (step S205) when the brightness of the lighting element 107 being the minimum brightness is the determined result in the step S211. When the brightness of the lighting element 107 not being the minimum brightness is the determined result in the step S211, the intensity of the driving signal DS is decreased gradually until the voltage level of the external power V_{EXT} rises back to the predetermined voltage level (step S212) so as to continuously drive the lighting element 107 with the intensity of the driving signal DS corresponding to the predetermined voltage level when the voltage level is not less than the predetermined voltage level (step S209).

In summary, the embodiment or other embodiments of the invention may have at least one of the following advantages.

The projector may regulate the power consumption for adapting to the number of watts (e.g. 2.5 W, or 5 W) capable of being supplied by a variety of external powers (e.g. USB power). In the aforementioned embodiments of the invention, the means to regulate the power consumption of the projector is regulating the brightness (the projection brightness of the projector) of the lighting element (i.e., LEDs). The variations in controlling the power consumption from fine scale to large scale is to make the projector may have a chance to maintain in operation no matter what the number of watts capable of being supplied by the external power connected with the projector by users is. Consequently, the projector is capable of long-term projection without limiting to the capacity of the battery and carrying bulky power adaptors around.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the present disclosure is intended to be dedicated to the public regardless of whether the element or component is explicitly recited in the following claims.

What is claimed is:

1. A projector, comprising:
a battery, for providing a battery power;
an interface, for receiving and transmitting an external power;
a selection unit, electrically coupled to the battery and the interface, for receiving the battery power and the external power, and selecting and outputting one of the battery power and the external power to be served as an operation voltage of the projector according to a control signal;
a lighting element;
a driver, electrically coupled to the lighting element, for receiving a driving signal and driving the lighting element accordingly; and
a central processing unit, electrically coupled to the battery, the interface, the selection unit, and the driver, for outputting the control signal with a first state to control the selection unit to select and output the external power when a capacity of the battery is insufficient and the interface receives the external power, and regulating an intensity of the driving signal outputted from the central processing unit according to a capacity of the external power so as to make the projector continuously maintain in operation.

2. The projector as claimed in claim 1, wherein the central processing unit further outputs the control signal with a second state to control the selection unit to select and output the battery power when the capacity of the battery is sufficient.

3. The projector as claimed in claim 2, wherein the central processing unit continuously detects the battery power to determine whether the capacity of the battery is sufficient, and the central processing unit outputs the control signal with the second state when the central processing unit detects the capacity of the battery is sufficient; and
the central processing unit outputs the control signal with the first state and detects whether the interface receives the external power when the central processing unit detects the capacity of the battery is insufficient.

4. The projector as claimed in claim 3, wherein the central processing unit executes a normal shutdown procedure to shut down the projector when the interface without receiving the external power is detected by the central processing unit.

5. The projector as claimed in claim 3, wherein the central processing unit outputs the control signal with the first state when the interface with receiving the external power is detected by the central processing unit.

6. The projector as claimed in claim 5, wherein the central processing unit further regulates the intensity of the driving signal to a minimum magnitude for regulating a brightness of the lighting element to a minimum brightness, and continuously detects a voltage level of the external power received by the interface after the central processing unit outputs the control signal with the first state.

7. The projector as claimed in claim 6, wherein the battery is a chargeable battery, and the selection unit further feeds back the external power to charge the chargeable battery after the central processing unit outputs the control signal with the first state.

8. The projector as claimed in claim 7, wherein the central processing unit further increases the intensity of the driving signal gradually until the voltage level falls to a predetermined voltage level after the central processing unit regulates the brightness of the lighting element to the minimum brightness.

9. The projector as claimed in claim 8, wherein the driver continuously drives the lighting element with the intensity of the driving signal corresponding to the predetermined voltage level when the voltage level is not less than the predetermined voltage level.

10. The projector as claimed in claim 9, wherein the central processing unit continuously determines whether the brightness of the lighting element is the minimum brightness when the voltage level detected by the central processing unit is lower than the predetermined voltage level.

11. The projector as claimed in claim 10, wherein the central processing unit executes the normal shutdown procedure to shut down the projector when the brightness of the lighting element determined by the central processing unit is the minimum brightness.

12. The projector as claimed in claim 10, wherein the central processing unit decreases the intensity of the driving signal gradually until the voltage level rises back to the predetermined voltage level when the brightness of the lighting element determined by the central processing unit is not the minimum brightness.

13. The projector as claimed in claim 8, wherein the predetermined voltage level is determined by the capacity of the external power, and the capacity of the external power is a number of watts capable of being supplied by the external power.

14. The projector as claimed in claim 1, wherein the interface at least comprises a universal serial bus interface.

15. The projector as claimed in claim 14, wherein the external power is provided by an apparatus equipped with the universal serial bus interface.

16. A power control method, adapted to a projector, the power control method comprising:
detecting whether a capacity of a battery of the projector is sufficient when the projector is in the power-on state;
detecting whether an interface of the projector receives an external power when the capacity of the battery is insufficient; and
regulating an intensity of a driving signal according to the capacity of the external power so as to make the projector continuously maintain in operation when the interface receives the external power.

17. The power control method as claimed in claim 16, wherein the step of regulating the intensity of the driving signal comprises:
regulating the intensity of the driving signal to a minimum magnitude for regulating a brightness of the lighting element to a minimum brightness and continuously detecting a voltage level of the external power;
increasing the intensity of the driving signal gradually until the voltage level falls to a predetermined voltage level; and
driving the lighting element continuously with the intensity of the driving signal corresponding to the predetermined voltage level when the voltage level is not less than the predetermined voltage level.

18. The power control method as claimed in claim 17, wherein the step of regulating the intensity of the driving signal further comprises:
determining whether the brightness of the lighting element is the minimum brightness when the voltage level detected is lower than the predetermined voltage level;
executing a normal shutdown procedure to shut down the projector when the brightness of the lighting element is the minimum brightness; and
decreasing the intensity of the driving signal gradually until the voltage level rises back to the predetermined voltage level when the brightness of the lighting element is not the minimum brightness.

19. The power control method as claimed in claim 16, further comprising:
providing a battery power to make the projector continuously maintain in operation when the capacity of the battery is sufficient.

20. The power control method as claimed in claim 16, further comprising:
executing a normal shutdown procedure to shut down the projector when the capacity of the battery is insufficient and the interface is not receiving the external power.
